(19) United States
(12) Patent Application Publication
(10) Pub. No.: US 2023/0059501 A1
(43) Pub. Date: Feb. 23, 2023

(54) Underwater Communication System

(71) Applicant: Naval Information Warfare Center Pacific, San Diego, CA (US)

(72) Inventors: Ayax Ramirez, Chula Vista, CA (US); Pei-Fang Wang, San Diego, CA (US); Saurabh Sharma, San Diego, CA (US); Ryan Lu, San Diego, CA (US); Bienvenido Melvin L Pascoguin, La Mesa, CA (US); Stephen D Russell, San Diego, CA (US)

(73) Assignee: THE UNITED STATES OF AMERICA AS REPRESENTED BY THE SECRETARY OF THE NAVY, San Diego, CA (US)

(21) Appl. No.: 17/407,268

(22) Filed: Aug. 20, 2021

(51) Int. Cl. H04B 13/02; H04B 1/38; F17C 7/00

(52) U.S. Cl. CPC H04B 13/02; H04B 1/38; F17C 7/00; H04B 7/00

(57) ABSTRACT

An underwater communication method includes creating an air column in a water body using a device including a device body, an air column-generating component, and a transceiver, thereby forming an air column to a surface of the water body. A signal is transmitted, received, or a combination of transmitted and received using the transceiver through the air column to the surface of the water body.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor.

### BACKGROUND

Communicating through water with underwater vehicles or electronic devices from the surface depends on the ability of different types of waves to be able to propagate through water. This is due to attenuation in water caused by absorption of waves by water molecules and scattering of the waves by different types of material suspended in the water. Communication methods require that the wave be able to propagate at a frequency between 10 Hz to 1 MHz in order to travel through water. The process of sending information from a source above the water to a receiver under the surface has been demonstrated using acoustic wave propagation, optical wave propagation, and optically generated acoustic waves. For example, since acoustic waves propagate at a frequency ranging from about 2 Hz to about 10 MHz, acoustic waves can be used in communication methods that go through water.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 is a flow diagram illustrating an example of the underwater communication method herein;

FIG. 2 is an operational diagram illustrating an example of the underwater communication method herein;

FIG. 3 is a schematic showing the generation of the air column using an the underwater communication method herein;

FIG. 4 is a simulated air plume with contours representing the percentages of air content in the cross-section (y-z) plane; and

FIG. 5 is another simulated air plume at the 50th second with contours representing the percentages of air content in the cross-section (y-z) plane.

### DETAILED DESCRIPTION

In general, underwater communication methods have been limited to using devices that can communicate using acoustic waves. This is because acoustic waves have the broadest propagation frequency through water compared to other types of waves (e.g., about 2 Hz to about 10 MHz). In some circumstances, electromagnetic (EM) waves in the optical region can propagate through water in a specific frequency of about 480 nm. However, EM waves at all other frequencies do not propagate through water well enough for any practical application. In addition, there are currently no methods of underwater communication that use the entire frequency spectrum of EM waves.

In the underwater communication method herein, the entire frequency spectrum of EM waves, including any radio frequency (RF) waves, can be used in the underwater communication method. This is accomplished because the underwater communication system herein creates air columns underwater that allow EM waves, including RF waves, to propagate through the air columns to the surface of a water body. Therefore, a signal can be generated using EM waves to communicate with a transceiver on the surface through the air column being generated in the water. In addition, the underwater communication method is inexpensive to implement compared to many above water devices in use that use EM waves for communication.

The underwater communication method herein includes creating an air column in a water body using a device including a device body, an air column generating component, and a transceiver, thereby forming an air column to a surface of the water body. A signal is transmitted, received, or a combination of transmitted and received using the transceiver through the air column to the surface of the water body.

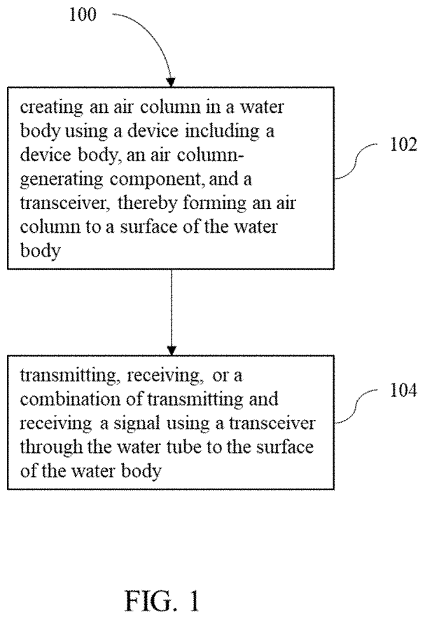

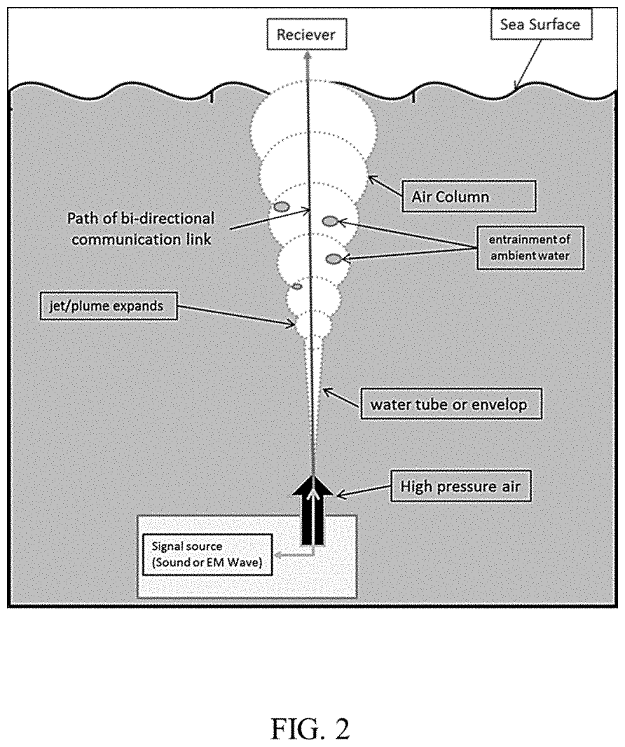

Referring now to FIG. 1, the underwater communication method 100 includes creating an air column 102 in a water body using a device including a device body, an air column-generating component, and a transceiver, thereby forming an air column to a surface of the water body. The water body may be any water body, such as an ocean, a lake, or a river. In some examples, the underwater communication method 100 may be conducted in a water body at a depth equal to or less than 65 ft. The air column may be generated by the device with the air column-generating component releasing gas from a pressurized air jet, generating air from an impeller or propeller, or a combination thereof. FIG. 2 shows an example of the air column produced by the device. Air produced by the device forms an air column or envelope, which gradually expands to form the air column that extends to the surface of the water body. In some examples, the air column may have a length equal to or less than 65 ft depending on the depth the device is positioned within the water body. The air column may also have a diameter ranging from about 1 inch to about 16 inches.

The device includes a device body that, in some examples, encloses the transceiver and an air column-generating component. In some other examples, the device body also encloses the transceiver and the air column-generating component, which includes at least one tank containing a high-pressure gas. In other examples, the device body has the transceiver and the air column-generating component attached to the outside of the device body, enclosed in the device body, or a combination thereof.

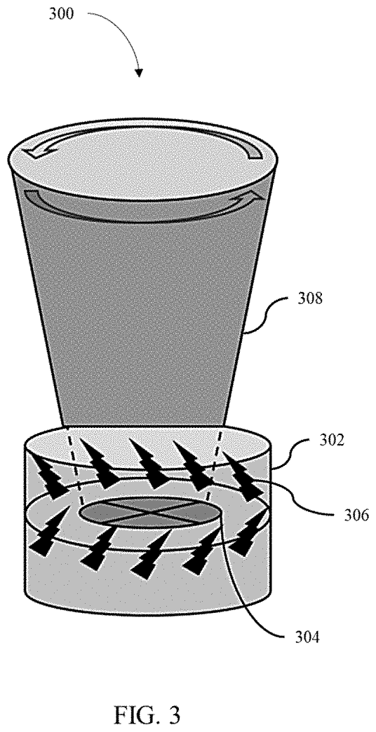

FIG. 3 shows an example of the device 300 with the device body 302 enclosing the air column-generating component 304. The air column-generating component 304 forces air through nozzles or gas jets 306 that form and shape the air column 308. The example shown in FIG. 3 shows ten nozzles or gas jets 306, but the device 300 may have two or more nozzles or gas jets 306 depending on the application of the device 300. The transceiver is not depicted in FIG. 3. In the example in FIG. 3, the air column-generating component 304 is located within the device body 302. The air-generating component 304 produces the air column 308 by forming an air column 308 from the location within the water body (e.g., equal to or less than 65 ft under the surface of the water body) to the surface of the water body. The air column 308 acts as a temporary “straw” for electromagnetic radiation at any frequency to travel from within the water body to the surface of the water body. Some examples of the air column-generating component 304 include a pressurized air jet, a propeller, an impeller, and a combination thereof. In other examples, the air column-generating component 304 includes more than one pressurized air jet, propeller, impeller, and combinations thereof.

In some examples, the air column-generating component 304 is a pressurized jet that includes at least one tank containing a high-pressure gas or at least one tank with a foam mixture of air and water. In some examples, the air column-generating component 304 may be enclosed within the device body 302. In other examples, the air column-generating component 304 may be attached to the outside of the device body 302. The gas or foam mixture forms the air column in the water body when released from the tank. Some examples of the high-pressure gas may be air, nitrogen, argon, helium, oxygen, and combinations thereof. In addition, the tank containing a high-pressure gas or foam mixture may have a gas pressure ranging from about 100 psi to about 500 psi. The high-pressure gas or foam mixture is released from the tank through two or more gas jets 306 in the device body 302 where each gas jet has a diameter ranging from about 5 mm to about 10 mm. The gas jets 306 in the device body 302 may have many different shapes to form different sized air columns. Some examples include gas jets with a shape selected from the group consisting of circular, oval, polygonal, orthogonal to the air column, an oblique angle to the air column, and combinations thereof.

In other examples, the air column-generating component includes a propeller or impeller, or a combination of multiple propellers or impellers. When a propeller or impeller is used, the device body 302 may have two or more nozzles 306 that allow the air to pass through, thereby forming the air column. The nozzles may have a diameter ranging from about 5 mm to about 10 mm. The nozzle 306 shape helps form the shape of the air column. For example, the two or more nozzles may have a shape selected from the group consisting of circular, oval, polygonal, orthogonal to the air column, an oblique angle to the air column, and combinations thereof.

Referring back to FIG. 1, the underwater communication method 100 includes transmitting, receiving, or a combination of transmitting and receiving a signal 104 using a transceiver through the air column to the surface of the water body. The transceiver may be located within the device body 302 or attached to the outside of the device body 302 and resistant to water. Some examples of the signal that may be used include an acoustic wave signal, a radio frequency signal, an optical wave signal (e.g., a laser signal, a light signal, etc.), and combinations thereof. In an example, the entire frequency spectrum of EM waves (including RF waves) may be used as the signal. In one example, the signal may be transmitted, received, or a combination thereof to or from the transceiver within the device from the water body to or from a surface transceiver on the surface of the water body. In another example, a surface signal is transmitted, received, or a combination thereof to or from a surface transceiver on the surface of the water body to or from the transceiver of the device from the water body.

The underwater communication method can be performed by an underwater communication system. The underwater communication system includes an air column-generating component, a transceiver, and a device body. The device body, air column-generating component, and transceiver may be the same device body, air column-generating component, and transceiver previously disclosed herein. The underwater communication system may also include the same air column-generating component, impeller, propeller, or combination thereof previously disclosed herein.

To further illustrate the present disclosure, examples are given herein. These examples are provided for illustrative purposes and are not to be construed as limiting the scope of the present disclosure.

### EXAMPLES

Modeling studies were conducted to simulate air jet or plume in a vertical cylinder filled with water. The cylinder was 0.6 m in diameter. Air was injected through a hole with a diameter of 10 cm at the bottom of the cylinder. A three-dimensional fluid dynamic model was used to simulate the air jet or plume dynamics for two test cases.

### Example 1

### Air Plume Simulation #1

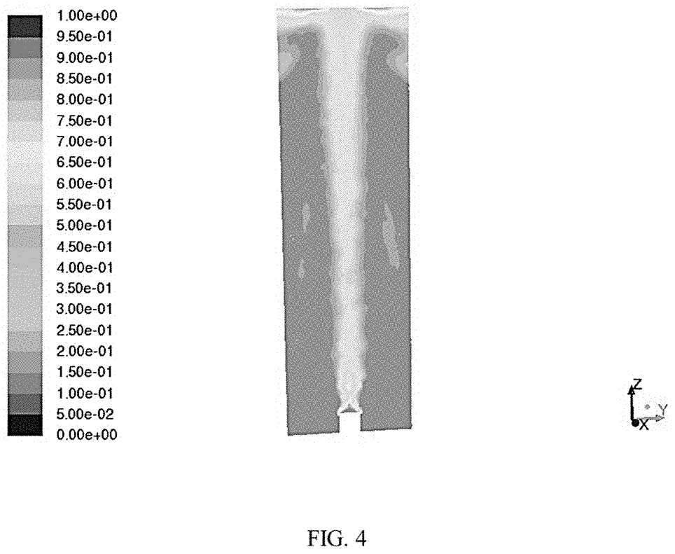

For the first simulation, a cylinder with a length of 2 m was used. FIG. 4 shows the simulated contour profiles of air content percentages for the first simulation at the 6th second after the onset of the air injection from the bottom hole. FIG. 4 shows, in 6 seconds, the air jet has reached a steady state throughout the water column. Air contents in the center of the plume range from about 20% to about 75% with the air content higher in the lower part than in the upper part of the cylinder.

### Example 2

### Air Plume Simulation #2

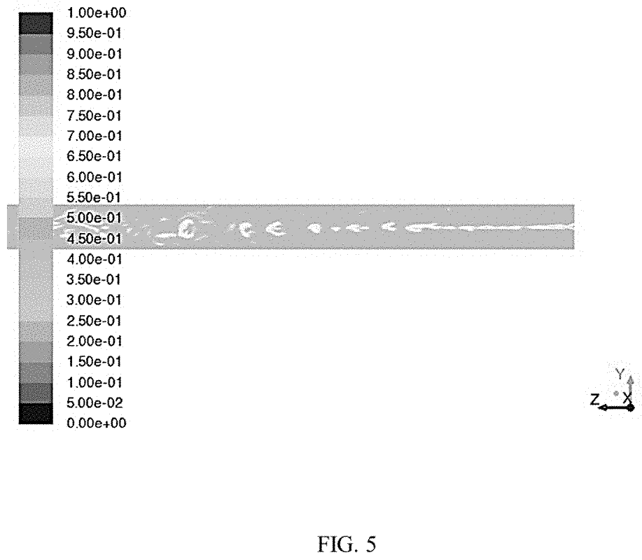

For the second simulation, a cylinder with a length of 100 m was used. FIG. 5 shows the corresponding results for the second simulation. At the 50th second, the air plume maintains a stable structure within 25 m of the lower part of the cylinder, which is primarily driven by the momentum from the inlet. As the air plume rises, the initial momentum is reduced and gradually driven by buoyancy. As the air plume continues to rise, the air plume cannot maintain a stable structure and is broken into pockets of air by the turbulence of the ambient flow. If the momentum of the air jet is increased at the bottom boundary, the range of a stable air-plume structure can be extended further upward.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 5 ft to about 65 ft should be interpreted to include not only the explicitly recited limits of from about 5 ft to about 65 ft, but also to include individual values, such as 7 ft, 29 ft, 43.5 ft, etc., and sub-ranges, such as from about 7 ft to about 45 ft, etc.

In describing and claiming the examples disclosed herein, the singular forms “a”, “an”, and “the” include plural referents unless the context clearly dictates otherwise.

What is claimed is:

1. An underwater communication method, comprising:
creating an air column in a water body using a device including a device body, an air column-generating component, and a transceiver, thereby forming an air column to a surface of the water body; and
transmitting, receiving or a combination of transmitting and receiving a signal using the transceiver through the air column to the surface of the water body.

2. The method of claim 1, wherein the air column-generating component is selected from the group consisting of a pressurized air jet, a propeller, an impeller, and a combination thereof.

3. The method of claim 1, wherein the signal is selected from the group consisting of an acoustic wave signal, a radio frequency signal, an optical wave signal, and combinations thereof

4. The method of claim 1, wherein the signal is transmitted, received, or a combination thereof to or from the transceiver in the device within the water body to or from a surface transceiver on the surface of the water body.

5. The method of claim 1, wherein a surface signal is transmitted, received, or a combination thereof to or from a surface transceiver on the surface of the water body to or from the transceiver in the device within the water body.

6. The method of claim 2, wherein the pressurized air jet includes at least one tank containing a high pressure gas or a foam mixture of air and water, wherein the tank containing a high-pressure gas forms the air column from a gas selected from the group consisting of air, nitrogen, argon, helium, oxygen, and combinations thereof.

7. The method of claim 6, wherein the air column is created by releasing the gas from the tank through two or more gas jets in the device body where the air column has a diameter ranging from about 1 inch to about 16 inches.

8. The method of claim 7, wherein the two or more gas jets or the two or more nozzles have a shape selected from the group consisting of circular, oval, polygonal, orthogonal to the air column, and an oblique angle to the air column.

9. The method of claim 1, wherein the air column has a length equal to or less than 65 ft.

10. The method of claim 1, wherein the air column has a diameter ranging from about 1 inch to about 16 inches.

11. The method of claim 1, wherein the underwater communication method is conducted at a depth equal to or less than 65 ft.

12. The method of claim 2, wherein the air column generating component creates the air column using more than one pressurized air jet, propeller, impeller, and combinations thereof.

13. The method of claim 6, wherein the pressurized air jet includes two or more gas jets with a diameter ranging from about 5 mm to about 10 mm and a gas pressure ranging from about 100 psi to about 500 psi.

14. The method of claim 6, wherein the impeller or propeller includes two or more nozzles with a diameter ranging from about 5 mm to about 10 mm.

15. An underwater communication system, comprising:
An air column generating component, wherein the air column generating component is selected from the group consisting of a pressurized air jet, a propeller, an impeller, and a combination thereof;
A transceiver, wherein the transceiver transmits, receives, or transmits and receives a signal to or from a surface transceiver on a surface of a water body; and
a device body, wherein the device body includes the air column-generating component, and the transceiver enclosed therein.

16. The system of claim 15, wherein a surface signal is transmitted, received, or a combination thereof to or from the surface transceiver on the surface of the water body to or from the transceiver.

17. The system of claim 15, wherein a pressurized air jet includes at least one tank containing a high pressure gas or a foam mixture of air and water, wherein the tank containing a high-pressure gas forms the air column from a gas selected from the group consisting of air, nitrogen, argon, helium, oxygen, and combinations thereof, the gas is released from the tank through two or more gas jets in the device body with a diameter ranging from about 5 mm to about 10 mm, and the tank has a gas pressure ranging from about 100 psi to about 500 psi.

18. The system of claim 17, wherein the gas jet has a shape selected from the group consisting of circular, oval, polygonal, orthogonal to the air column, and an oblique angle to the air column.

19. The system of claim 15, wherein the air column-generating component includes more than one pressurized air jet, propeller, impeller, and combinations thereof.

20. The system of claim 15, the air-generating component includes two or more nozzles with a diameter ranging from about 5 mm to about 10 mm.
